(19) United States
(12) Patent Application Publication
(10) Pub. No.: US 2015/0193799 A1
(43) Pub. Date: Jul. 9, 2015

(54) INTERACTIVE USER INTERFACE FOR RECEIVING AND DISPLAYING MARKET INFORMATION

(71) Applicant: Amadeus S.A.S., Biot (FR)

(72) Inventors: Nabil Behlouli, Antibes (FR); Roger El Khoury, Mougins (FR)

(21) Appl. No.: 14/662,513

(22) Filed: Mar. 19, 2015

Related U.S. Application Data
(63) Continuation of application No. 13/194,879, filed on Jul. 29, 2011.

(30) Foreign Application Priority Data
Jul. 1, 2011 (EP) 11305856.4

(51) Int. Cl. G06Q 30/02; G06F 3/0484

(52) U.S. Cl. CPC G06Q 30/0206; G06F 3/04842

(57) ABSTRACT

The method according to a preferred embodiment of the present invention allows a comprehensive and unbiased analysis on hotel prices for a market. It allows positioning of a particular hotel vis-a-vis the market characteristics where it is located. This market price analysis is integrated into a revenue management system in order to update price recommendations based on market elements which are external to the hotel. The method according to the present invention poses no limit to the number of competitors against whom the hotel's own rates are benchmarked, its purpose being to provide a global market vision. Hoteliers do not even need to figure out whom they are competing with. The method provides new analyses on market trends, and it allows the hotel user to truly position his property vis-a-vis the market over time. At last, it provides insightful recommendations based on user rules which are self explainable.

### CROSS-REFERENCE TO RELATED APPLICATIONS

This application is a continuation of U.S. application Ser. No. 13/194,879, filed Jul. 29, 2011 (pending), which claims the benefit of European Patent Application No. 11305856.4, filed Jul. 1, 2011, the disclosures of which are hereby incorporated by reference in their entirety.

### FIELD OF THE INVENTION

The present invention relates to the field of management of inventory data, particularly to a method and system for revenue management of resources (e.g. travel resources such as hotel rooms, car rental, or tickets for shows or sport events) based on market pricing.

### BACKGROUND OF THE INVENTION

Service resources, in particular travel related resources (e.g. hotel rooms, rented cars, flight seats), but also for example tickets for shows or sport events must be treated as perishable goods as they are lost if not sold in time. To try to maximize the revenue and the exploitation of such resources, several techniques have developed in recent years, normally called revenue techniques. They are based on the attempt to understand the customers' needs and requests in order to sell as many resources as possible together with maximizing the revenue. One of the goals of the revenue management techniques is to maximize the exploitation of the available resources, i.e. to minimize the available resources which are not allocated, for example empty rooms in a hotel or non-rented cars for a rental company. Any resource which is not allocated by a certain time is a loss for the company. A key factor is the price at which the resource is offered, which should take into considerations many aspects, including the availability of similar resources by possible competitors.

Revenue management has always been an integral part of hotel operations, and for that matter, early automated systems were good at comparing booking up patterns for different market segments against historic trends and then recommending rate and length of stay adjustments.

Today things are different. With the Internet distribution playing an increasingly dominant role, the reference marks of old have substantially lost their relevance. Market segments have become harder to distinguish as guests now book through multiple channels, more impulsive buying habits give hotels less time to react to new trends and prices have become more volatile than ever.

As a result, revenue management systems for hotels have moved away from the traditional management of inventory and capacity allocation to embrace price optimization based on a combination of competitor rate analysis and demand forecast.

However, for hotels that are not competing on price alone, or simply for hotels that operate in a large marketplace with hundreds of hotels all possibly competing, there is no revenue management today that can truly answer their requirements.

State of the art revenue management is currently relying on third party rate shopping tools, which search for competitive rates on a number of channels.

The tools require that the hotel user explicitly identify the competitive set and the channels on which the rate search will be performed.

The rate shopping tool providers levy a search fee on each search transaction performed by hotel, by date, by channel, or by rate type. These rate shopping tool providers do not necessarily have an agreement with the channels they do shopping on. Therefore, when they don't, it may result in service disruption to the end user—when the channel changes or cuts off access to its information. Also, the number of hotels which can be shopped for is limited for both performance and cost reasons. It is usually less than 20, for less than 10 channels. Another drawback of rate shopping tools is that they normally necessitate a prior definition of a competitor set. Now, it turns out that most hotels do not exactly know whom they are competing with.

Commercially available revenue management systems normally use the competitor information either as an overlay next to their own price recommendations (there is no added value), or in a black box fashion, overriding the current recommendation by a new price without an explanation. This can be a problem as the direct competitor set does not always reflect the real competition of the hotel, and competitors' prices may fluctuate without any reason, affecting negatively/wrongly the hotel price recommendations.

### OBJECT OF THE INVENTION

An object of the present invention is to alleviate at least some of the problems associated with the prior art systems.

According to one aspect of the present invention, there is provided a revenue management method for maximizing, through a client-server data processing system, the exploitation on a predetermined time interval of a plurality of perishable service resources by a first provider of service resources, each resource of the plurality of service resources being classified according to a plurality of criteria and having an expected offer price, the data processing system having access to a database containing information on price of service resources offered by a plurality of competitor providers of service resources, the method including the steps of: obtaining from a repository information on service resources of the first provider according to the plurality of criteria; selecting a set of providers of the plurality of competitor providers, offering service resources having a score indicative of the similarity of the resource with the resources of the first provider, the similarity being based on at least one of the plurality of criteria; enquiring the database for obtaining information on price of service resources of selected providers; estimating an average price of selected resources for the predetermined time interval; adjusting the expected offer price according to the estimated average price and a set of predetermined market influencer parameters.

The method according to a preferred embodiment of the present invention allows a comprehensive and unbiased analysis on hotel prices for a market. It allows positioning of a particular hotel vis-a-vis the market characteristics where it is located. This market price analysis is integrated into a revenue management system in order to update price recommendations based on market elements which are external to the hotel.

The method according to the present invention poses no limit to the number of competitors against whom the hotel's own rates are benchmarked, its purpose being to provide a global market vision. Hoteliers do not even need to figure out whom they are competing with.

The method provides new analyses on market trends and it allows the hotel user to truly position his property vis-a-vis the market over time. At last, it provides insightful recommendations based on user rules which are self explainable.

The method according to a preferred embodiment of the present invention provides a comprehensive and unbiased analysis on hotel prices for a market. It allows positioning of a particular hotel vis-a-vis the market characteristics where it is located. This market price analysis is integrated into a revenue management system in order to update price recommendations based on market elements which are external to the hotel. To gather the needed information, the market pricing tool is connected to a source of information providing such data, and the analysis is based on the data extracted from the hotel distribution platform. More generally, those skilled in the art will appreciate that such data can be obtained from any rate shopping tools (e.g. Rubicon, TravelClick, eClerx, Rate Tiger to name a few). The more complete and up to date the rate shopping tool is, the more accurate the market price analysis will be.

Finding a relevant correlation between market prices and time periods is another important issue which is addressed by the method and system of the present invention. In a preferred embodiment of the present invention, the traditional R² coefficient which measures the correlation degree between variables is increased using a Meier smoothing method period 3 based on a floating average concept.

Because hotel descriptive content (rate codes, room types) is not formatted, a semantic analysis algorithm to fine tune the search algorithm would be beneficial. The algorithm used in a preferred embodiment of the present invention is error-tolerant, which means that it detects string occurrences which are ‘close to’ the initial search item (for example, best unrestricted rate for best available rate).

The advantages of the present approach consists in the ability:
to search on large hotel content with heterogeneous rate and room type descriptions;
to aggregate such content and determine a correlation between prices and time leads; and
to integrate the correlation analyses into the revenue management price recommendations.

According to a second aspect of the present invention, there is provided a system comprising one or more components adapted to perform the method described above.

According to a further embodiment of the present invention there is provided a computer program comprising instructions for carrying out the method described above when said computer program is executed on a computer system.

### BRIEF DESCRIPTION OF DRAWINGS

Reference will now be made, by way of example, to the accompanying drawings, in which:

FIG. 1 is a diagram of a Revenue Management System including the market pricing tool in accordance with one embodiment of the present invention.

FIG. 2 is a diagram of a general computer system adapted to support the method of a preferred embodiment of the present invention.

FIG. 3 is a schematic representation of the main software components of the system according to a preferred embodiment of the present invention.

FIG. 4 shows the steps to retrieve hotel availability with a method according to an embodiment of the present invention.

FIG. 5 shows a diagram example of price evolution over 7 days.

FIG. 6 shows a diagram example of comparison between competitors' trend.

FIGS. 7 to 17 show some user interface screen shots of a possible application implementing the method of the present invention, and

FIG. 18 is a diagram showing the flow of information according to one embodiment of the present invention.

### DETAILED DESCRIPTION OF THE EMBODIMENTS

The market pricing method according to a preferred embodiment of the present invention is a new way at looking globally at a hotel market, a market being defined as a geographical region (a city, an area of interest, a destination, etc.) which generates demand. Of course, not all hotels will benefit equally from the demand for the market, but all are depending on it. The market pricing method includes recording over time the market price trends and the relative positioning of a specific property vis-a-vis the market in which it operates in order to influence the price recommendations which are computed, e.g. in real time, using the unconstrained demand for the specific property. The unconstrained demand for a product (in this case, a hotel room) is the amount of reservation requests which can be expected for this product, irrespective of its price and availability. It is a major output of all state-of-the-art revenue management systems.

According to a preferred embodiment of the present invention, the method takes advantage of the tremendous wealth of data on hotel rates and availabilities which is held in any appropriate database. Because such a database may host information from thousands of hotels, it provides an exhaustive vision of any market, and in particular of the market in which a specific hotel operates. Coupled with a powerful search algorithm, and a semantic analysis of hotel content description, this invention is a real breakthrough in hotel revenue management. Thanks to this, there is no need any more to search manually for competing hotels, nor to create and maintain fastidious lists of competitors.

However as mentioned above, those skilled in the art will appreciate that other rate shopping tools could be used instead.

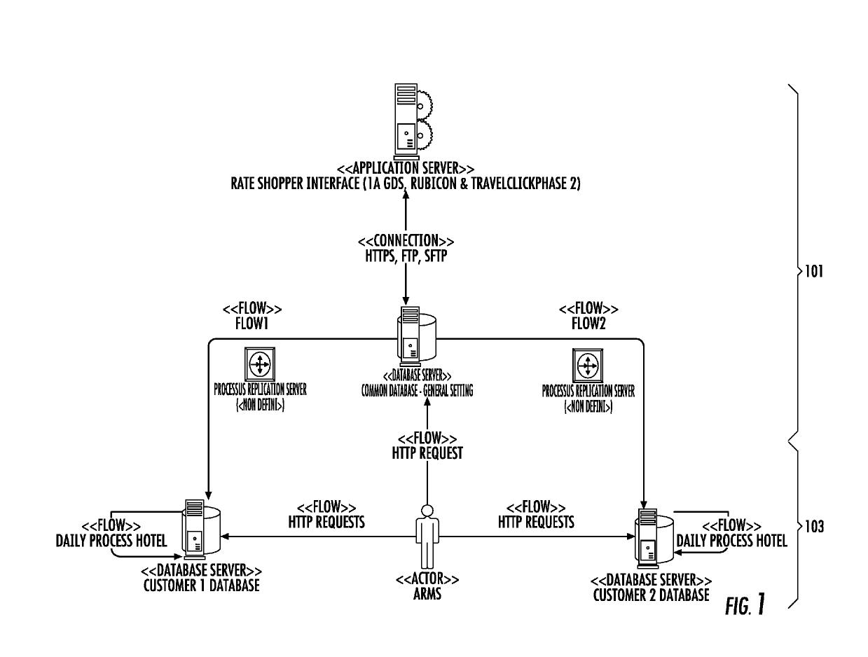

FIG. 1 shows a Revenue Management System suitable to implement the method and system according to a preferred embodiment of the present invention. The whole system includes two separate sections. The first one 101 is controlled by an Application Server and is necessary for collecting data from a rate shoppers module. In a preferred embodiment of the present invention, an automatic process is triggered on daily basis to retrieve data from different rate shoppers. The data will be first stored in the common database for all rate shoppers and customers. The information shopped from the different interfaces is controlled before being replicated in the different customers' databases.

The second section 103 is for data aggregation. In a preferred embodiment of the present invention, the data aggregation process is integrated in the daily hotel processing scripts, more specifically during the best available rate calculation. The objective is to calculate dynamic best available rate with the market trend impact.

The method according to a preferred embodiment of the present invention can be implemented in a Revenue Management System (RMS). The Revenue Management System according to a preferred embodiment of the present invention is organized according to a client/server architecture, wherein the Database Server receives customer requests by a plurality of client modules, each client module acting on behalf of one or more customers (e.g. a hotel or travel agent).

The technical architecture will be scalable and totally Web 2.0 compliant.

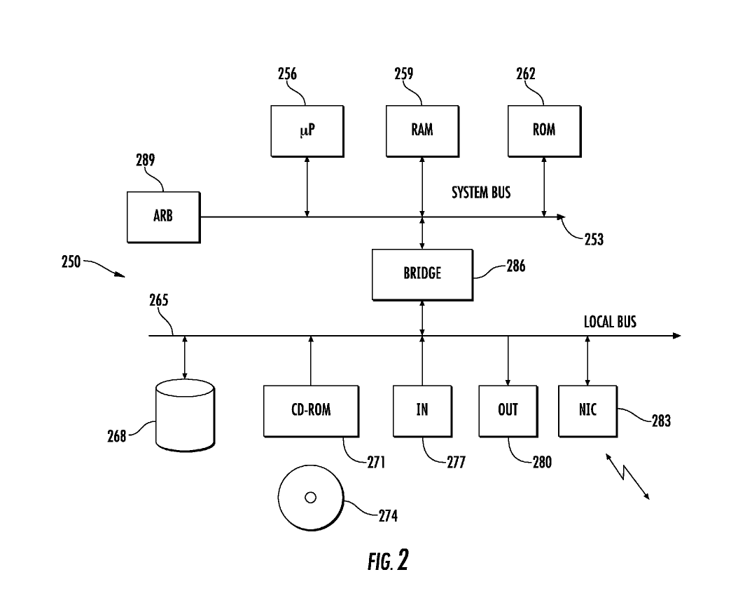

With reference to FIG. 2, a generic computer of the system (e.g. computer, market pricing module server, database management subsystem, router, or network server) is denoted with 250. The computer 250 is formed by several units that are connected in parallel to a system bus 253. In detail, one or more microprocessors 256 control operation of the computer 250, a RAM 259 is directly used as a working memory by the microprocessors 256, and a ROM 262 stores basic code for a bootstrap of the computer 250. Peripheral units are clustered around a local bus 265 (by means of respective interfaces). Particularly, a mass memory consists of a hard-disk 268 and a drive 271 for reading CD-ROMs 274. Moreover, the computer 250 includes input devices 277 (for example, a keyboard and a mouse), and output devices 280 (for example, a monitor and a printer). A Network Interface Card 283 is used to connect the computer 250 to the network. A bridge unit 286 interfaces the system bus 253 with the local bus 265. Each microprocessor 256 and the bridge unit 286 can operate as master agents requesting an access to the system bus 253 for transmitting information. An arbiter 289 manages the granting of the access with mutual exclusion to the system bus 253. Similar considerations apply if the system has a different topology, or it is based on other networks. Alternatively, the computers have a different structure, include equivalent units, or consist of other data processing entities (such as PDAs, mobile phones, and the like).

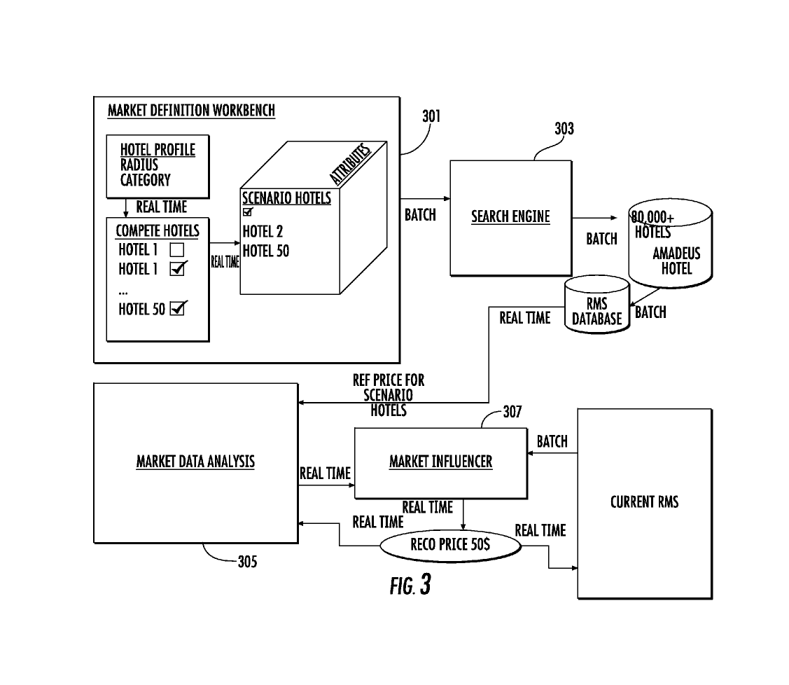

The method according to a preferred embodiment of the present invention is organized in 4 main functional modules as represented in FIG. 3. The 4 functional modules, each one allowing customization by the user, are: Market Definition Workbench module 301, Market Search Engine 303, Market Data Analyses module 305 and Market Influence module 307. Each module will be now described in detail.

### Market Definition Workbench Module

This module defines the characteristics of the competing set (using e.g. a semantic text search algorithm) and to launch an availability search over the refined set. The user interface allows the hotel user to perform the following actions:
browse through the imported data, and while doing so, set a weight to hotels of the list;
exclude some of the hotels from the final market list; and
request availability for the hotels of the resulting short list.

In order to prepare for the availability search, a default search profile is defined for all hotels. In a preferred embodiment, it contains e.g. the following information:
Length of stay, that is, the ability to request an availability by date of arrival and by length of stay;
Number of guests, i.e. the ability to request availability for a total number of guests per room; and
Horizon, i.e. the time period in the future for which the availability should be checked.

The hotel profile could be updated by the user.

In order to facilitate the hotel competitor selection, a default list of neighbors/competitor is displayed in administration screen. This list is ordered by geographical localization of the hotel neighbors.

An automatic selection of the competition set can be provided by an interface with a third party that will base the selection on hotel profile and services comparisons. The list could be overwritten by the user.

Using again the web service API, the availability will be looked for in the hotel distribution platform and then stored in the Revenue Management database. This process will be run typically on a daily basis. At this stage, the user will select the rate types and the room types, which will be integrated into the market pricing analysis. Because rates and room types are specific to each hotel and there is little standardization, an algorithm has been developed which performs semantic search on the imported hotel data to facilitate this task.

### Market Search Engine

With this module, the hotel user can define the market in which the hotel operates. Basing his search on e.g. the Point of Reference (POR) application, the user will typically define a radius—in miles or in kilometers—(e.g. by default set to 10 Km), which will be used by the search engine to look for all the hotels which are located within the specified distance of the user hotel. The search can be refined to include only hotels of a specific category (Hotel Profile). The search engine will extract the data from the hotel distribution platform relying on the web service API. The corresponding data is then loaded into the Revenue Management database. Typically, this module will be run from time to time, for example once per month.

Necessary steps for any Rate Shopping Interfaces:

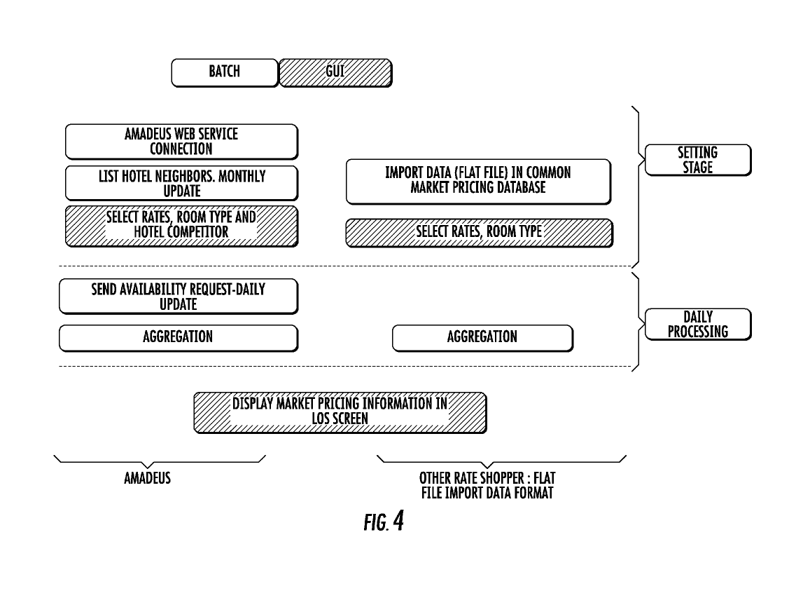

Different steps to retrieve hotel availability have to be implemented as represented in FIG. 4. Two steps are mandatory to retrieve data from the rate shoppers and aggregate them. The setting stage is different from one rate shopper to another, depending on the way the data is retrieved. The refresh of the data must be made once per month for the steps of neighbor hotels selection and profile pickup. As for the rates themselves, they can be refreshed once a day whatever the data feed.

The aggregation step is common to all rate shoppers and included in the daily processing of the hotel.

In order to set up the market pricing functionality, the hotel neighbors' list will be downloaded by running a specific command that will insert the specified user hotel into the common market pricing database with specific data retrieved from the customer database, such as the “hotelcode_id, hotelcode and database_id”. Then the list of neighbor hotels will be retrieved from the relevant Web services in a given radius (e.g. 10 kilometers).

This request is triggered once a month to add a new hotel neighbor when detected. It uses global parameters to import hotel's neighbors such as:
Exact hotel name in the appropriate database
Country code
Search horizon: G for Km and M for Miles. By default, the radius search will be set to 10 Km.

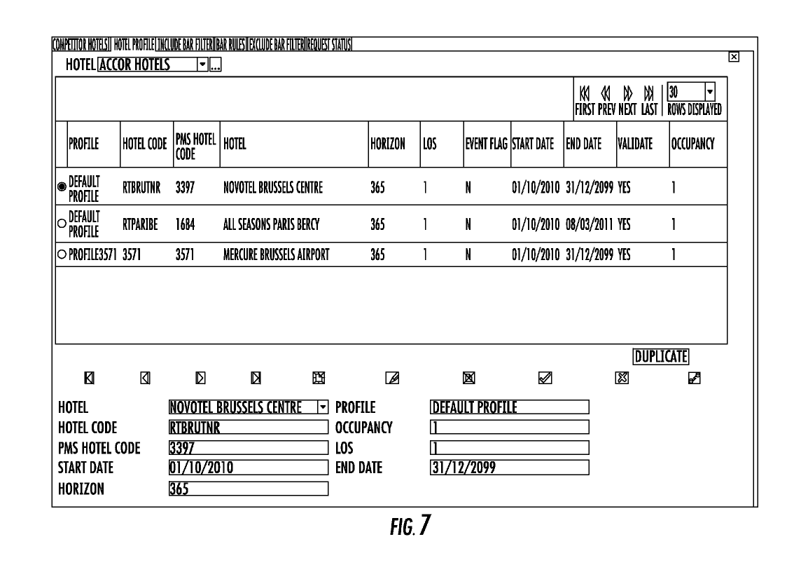

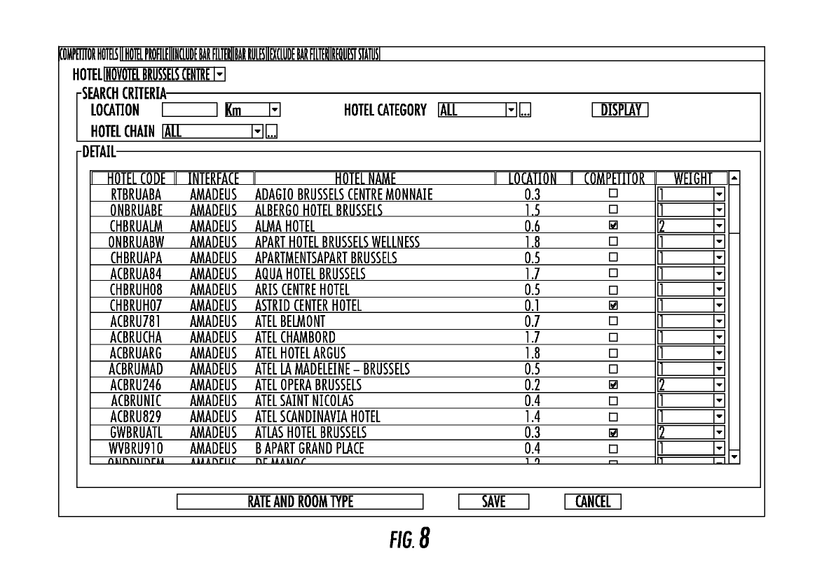

To set up the list of competitors, two screens are created: hotel profile and hotel competitors' screens (e.g. as described later with reference to FIG. 7 and FIG. 8). The hotel profile screen is used for the interface for the other rate shoppers. The required profile is predefined on the relevant application.

The hotel profile screen enables user to define the attributes of availability requests for each hotel to be run on a daily basis. The competitors set screen allows a user to select a short list of hotels competitors among the complete neighbors' list.

If the user hotel is not available in the appropriate database, the command can be launched based on the hotel city code in order to retrieve all the hotels located in this city from the existing neighbor hotel list of the hotel database.

Competing Hotels

Once the neighbors' list is downloaded, the user will be informed and requested to validate or overwrite his competitors from the neighbors' list display of the market definition workbench. The user is able to sort out the neighbors display lists with the followings criteria:
Geographical location of the hotel neighbors, for example 10 km (6.25 miles), which is a value defined at the hotel level.
The hotel chain code(s) requested—if any.
The hotel category(ies) (number of stars).

The neighbors/competitors list is saved in the database. The search query will return the result in real-time.

From the global exhaustive list of neighboring properties, the user can further refine the selection and associate specific weights to each competitor retained. The weight varies from 1 to 3 and this value will impact the market price value.

The user defines the room types and rates for which he wants to have competitive information.

The hotels extracted from different interfaces will be merged in the trend and tendency calculation. The trend is calculated for the whole market set. The display will hold indication of the data source for each hotel.

Availability Query

To build availability requests, the hotel profile and hotel competitors need to be set up beforehand. The automatic process is triggered on a daily basis to retrieve the availability information that is obtained by running another command on the web services.

A semantic analysis calling for a label parsing process of room rates and of label types and an availability process are executed at the same time as the availability request in order to pick up the list of unrestricted rates containing the Best Available Rate character in the rate description field.

### Market Data Analyses Module

The objective of this module is to analyze the selected hotel data to compute a market price and a market trend and to assess the overall market stability.

Market price: the market price is the weighted average of the prices of the hotels from the short list. The weights are those defined by the user in the workbench.

Market trend: the market trend is computed over a variable time period: past 7 days, 14 days or 28 days. It is calculated using a linear regression model between market price and time combined with a Meier smoothing algorithm in order to improve the correlation between the two variables. Maximum and minimum market trends are also determined over the selected time period.

Market stability: when the correlation falls below a given threshold, the market is flagged as unstable.

The new price recommendation display includes the new dynamic pricing functionality based on the imported data eventually completed by other rate shopping data. The values of the Best Availability Rate (BAR) influenced by the market price can be overwritten by any value entered by the user. Usually hotels sell at a rate which fluctuates according to their demand forecast. The rate can take on different values which are known as BAR levels. A typical hotel chain may have 10 to 20 such levels in a season. The revenue management system may recommend moving the price rate up or down using these levels.

The market pricing module computes and delivers the following information:

### Market Share

The hotel market share is the number of rooms of the hotel as a percentage of the rooms in the hotel's competitive market set. The market set is the total number of rooms the hotel is in direct competition with, within its area's market and/or segment.

Example: My hotel (100 rooms) divided by Total Market Set (1,000) equals the Market Share of 10%

### Market Price

It represents an average price for all the competitors set defined by the user and for the entire horizon (current date+365 days).

Market Price (Day D)=Σ competitors (i) price for D*weight (i)/Σ(weight)*number of competitors.

### EXAMPLE

TABLE 1
Average Market Price (Future Dates)

Occupation Date

| | | 1 Aug. | 2 Aug. | 3 Aug. | 4 Aug. |
|---|---|---|---|---|---|
| Hotel | Weight | 2010 | 2010 | 2010 | 2010 |
| Hotel A | 1 | 124 | 128 | 128 | 129 |
| Hotel B | 1 | 123 | 127 | 127 | 128 |
| Hotel C | 1 | 123 | 123 | 123 | 124 |

### Market Tendency

If it is assumed that the market tendency follows a linear trend, the market trend is the tangent of the linear tendency or regression line y=at+b.

Where

a=covariance(T,y)/variance(t), −1≦a≦1.

Variance(T)=sum t2−(average(T))²/N

b=average(y)−a*average(T)

R²=(covariance(T,y))²/variance(T)*variance(y).

The correlation coefficient R² measures the dependency between the market price and time slots. If the value is close to 0, it means there is no relationship between the two variables and in this case the market is not stable. In this case, if R² is equal or lower than a given market stability coefficient—MSC (value defined at database level)—the market is unstable. No recommendations are then calculated and the market trend is flagged as “unstable”.

By default a Meier smoothing method period 3 based on floating average concept will be applied in order to get a better correlation coefficient.

Meier Smoothing Method

X=1, 2, 3, 4, 5, 6 and 7

Y=556, 580, 610, 640, 740, 845, 975

Then X1=(1+2+3+4)/4=2.5

Y1=(556+580+610+640)/4=596.5

X2=(5+6+7)/3=6

Y2=(740+845+975)/3=853.33

Meier line regression becomes:

853.33=a*6+b

−596.50=a*2.5+b

=256.83=a*3.5>a=73.38(256.83/3.5)b=596.6−(2.5−73.38). Y=73.38*X+413.15

### Market Trend

The market trend indicator is based on the market tendency describing the market price evolution for 7 days, 14 days, or 28 days before current day. The trend used in the batch is displayed by default.

The trend is calculated for the following periods: 7 days, 14 days, and 28 days. The above trends are defined at the database level for all hotels.

Two methods exist to calculate the market trend. The first one is based on the regression line and market tendency and the second will use the difference in terms of price between the first day of the trend and the last one.

### Tendency Method

market trend %=a(tangent of the line y=at+b)*100/price (of the day).

Example: Occupation date Jan. 8, 2010, current date Jan. 6, 2010, short term trend D-7 and competitors set containing 3 hotels.

The regression line uses the 7 days trend average market price calculated day by day for the 3 hotels to determine tangent line and deduce the trend of the occupation day.

TABLE 2
Trend Calculation For Occupation Day Jan. 8, 2010
(Short Term Trend—7 Days)

| | May 26 | May 27 | May 28 | May 29 | May 30 | May 31 | Jun. 1 |
|---|---|---|---|---|---|---|---|
| Hotel A | 121 | 122 | 122 | 124 | 124 | 125 | 124 |
| Hotel B | 124 | 121 | 121 | 123 | 124 | 124 | 123 |
| Hotel C | 123 | 123 | 124 | 124 | 123 | 124 | 123 |
| Average Market Price 7 | 123 | 122 | 122 | 124 | 124 | 124 | 123 |
| Day Trend | | | | | | | |

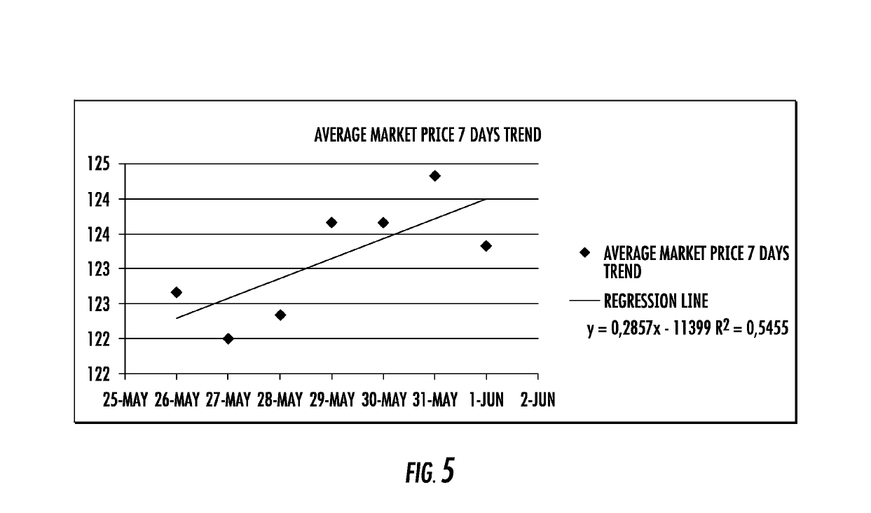

FIG. 5 shows a graphic representation of the example above.

The average market price of the occupation date calculated by the above formula (market price) is equal to 123 Euros. The market tangent calculated by the tendency formula is equal to 0.2857. The market trend for the Aug. 1, 2010 is equal to:

((0.2857/123)*100)*nbr of day of the trend (7 days)=1.62%.

The same approach is used to calculate the market trend over 14 days or 28 days.

### Delta Method

The trend in this method represents the difference (percentage) between the market price for the last day and the price of the market for the first day of the trend:

market trend % (7-day trend)=((Price (day7)−Price (day1))/Price (day7))*100

In the above example: trend (26-May)=123, trend (1-Jun)=123

market trend % (7-day trend)=((123−123)/123)*100=0%.

Minimum and Maximum Market Trends

Example: Occupation date Jan. 8, 2010, current date Jan. 6, 2010 and short term trend D-7. For competitors set containing 3 hotels: Hotel A, Hotel B and Hotel C. The price evolution for 7 previous days is given in Table 3.

TABLE 3
Competitors Price Evolution for Occupation Day Jan. 8, 2010

| 7 day trend/ | | | | | | | | | |
|---|---|---|---|---|---|---|---|---|---|
| competitor set | May 26 | May 27 | May 28 | May 29 | May 30 | May 31 | Jun. 1 | -> | Aug. 1 |
| Hotel A | 121 | 122 | 122 | 124 | 124 | 125 | 124 | | 124 |
| Hotel B | 124 | 121 | 121 | 123 | 124 | 124 | 123 | | 123 |
| Hotel C | 123 | 123 | 124 | 124 | 123 | 124 | 123 | | 123 |
| Market Price | 123 | 122 | 122 | 124 | 124 | 124 | 123 | | 123 |
| My Hotel Price | 117 | 118 | 119 | 118 | 119 | 120 | 121 | | 121 |

For each competitor the regression line (tendency curve) is calculated based on the trend selected by the user (combo box market trend) and the following formula:

Trend %=(tangent/occupation day price)*100

The minimum and maximum trends are determined according to the above formula. In this example the min & max trend are:

Hotel A trend %=(0.6/124)*100*7=3.38% (max trend)

Hotel B trend %=(0.21/123)*100*days trend=1.95%

Hotel C trend %=(0.03/123)*100*days trend day=0.17% (min trend)

market trend %=(0.28/123)*100*days trend=1.59%

My hotel trend %=(0.57/121)*days trend=3.29%

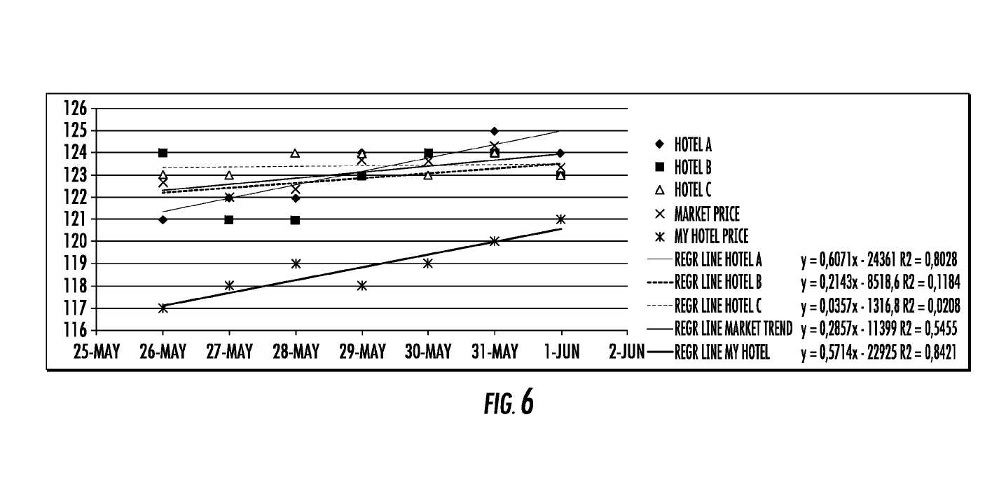

FIG. 6 shows the Competitors, the market and the “My Hotel” trend according to the present example.

An example of calculation is given in Table 4 for 30 days (occupation dates).

TABLE 4
Min & Max Market Trend Calculation

| | Aug. 1 | Aug. 2 | Aug. 3 | Aug. 4 | Aug. 5 | Aug. 6 | Aug. 7 | Aug. 8 | Aug. 9 | . | Aug. 31 |
|---|---|---|---|---|---|---|---|---|---|---|---|
| Market | 1.59 | 1.17 | 1.22 | 1.27 | 1.32 | 1.37 | 1.42 | 1.62 | 0.05 | | 1.15 |
| Trend % | | | | | | | | | | | |
| Maximum | 3.38 | 1.42 | 1.47 | 1.52 | 1.57 | 1.62 | 1.67 | 1.87 | 3 | | 4 |
| Market | | | | | | | | | | | |
| Trend % | | | | | | | | | | | |
| Minimum | 0.17 | 1.17 | 1.22 | 1.27 | 1.32 | 1.37 | 1.42 | 1.62 | 0.05 | | 1.15 |
| Market | | | | | | | | | | | |
| Trend % | | | | | | | | | | | |
| My Hotel | 3.29 | 1.29 | 1.3 | 1.31 | 1.32 | 1.33 | 1.34 | 1.35 | 1.36 | | 1.58 |
| Trend % | | | | | | | | | | | |

### Market Influence Module

This module relies on the market analyses described above to influence the hotel pricing. This is done by defining market impact rules. A market impact rule is a recommendation to increase or to decrease a rate level based on:
The comparison of the market price with the hotel current rates;
The comparison of the hotel current rates with some pre-designated hotel competitors;
The hotel strategy, which is either:
   A follower strategy, in which case market price variations will also tend to apply to the hotel,
   Or a leader strategy, where the hotel will be less sensitive to such market variations,
The market trend, when the trend has not been flagged as unstable.

The outcome of this module is a new price recommendation which is then sent to the distribution channels in real time.

### Strategy

It contains one of the 2 items leader or follower defined at hotel level (def_hotel) in the hotel screen.
Follower strategy: In this strategy the hotelier considers that he has a similar product and price than competitors. In this case, he follows the market price variation by applying the same market fluctuation ratio.
Leader strategy: The market leader dominates its competitors in term of: customer loyalty, distribution, segment of client, product quality and sales revenues. In this case, the hotelier is less sensitive to market price variation.

### Market Reactivity

The user defines an upper and a lower band which will serve as boundaries to detect if the market is flat (when the trend remains within these boundaries) or whether the market is growing (when the trend goes beyond the upper bound) or declining (below the lower bound).

### Hotel BAR Driven by Market Trend

This new functionality allows the hotelier to be more market oriented by adapting his pricing strategies regarding the market variations. The different parameters such as competitor's price, market price stability/consistency, and strategy chosen by the hotel (leader or follower) can be mixed in order to provide a framework to facilitate pricing decisions. The former parameters can be combined to provide the user with several scenarios. At the end, the best trade off is applied. The leader or follower strategy is applied at the hotel level.

### Market Price vs. My Hotel BAR (In Terms of Bar Level)

The market price calculated above (average price of all the competitors per day) is compared to the hotel BAR to determine the position of the hotel price versus the market price. For example if the market price of the day is 123 Euros and my current BAR calculated by the system is 90 Euros, it means the market price is 2 levels greater than the current hotel BAR (++).

### Market Impact Rules

The traditional price recommendations (usually expressed as a BAR level) resulting from the revenue management optimization are then influenced by the market analyses described above.

This influence is materialized by a set of business rules which rely on the following criteria:
The comparison of the market price with My Hotel current price,
The comparison of my direct competitors prices with My Hotel current price,
The market trend: the market is considered flat (=) when the market trend of the day is moving within a range included between boundaries which are predetermined by hotel and by time leads (7 days, 14 days, 28 days),
The price strategy, and
The weight given to each competitor.

The business rules take the form of a multi-criteria analysis yielding a score for each of the above criteria. If the score is positive, the outcome will be a recommendation to increase current price by one or two BAR levels. A maximum of two is set for the level increase to avoid too extreme price fluctuations. Likewise, if the score is negative, the outcome will be a recommendation to decrease by one or two BAR levels.

The details of the following paragraphs are given, as a specific example, with reference of the platform architecture and user interface. However those skilled in the art will appreciate that similar functions could be implemented with other systems or applied to other industries (e.g. airlines, car rental, camping), provided the necessary adaptations to user interface and market information are realized.

### Hotel Profile Screen

This screen is located in the menu (administration/configuration/parameters). It allows the user to create a profile for hosted hotels in RMS using the market pricing tool (see FIG. 7). The user must be able to create, modify and delete his hotel profile. The user must have the appropriate access right to be authorized to manage the allowed hotels. Each profile has a validity period. The profile could be duplicated to several hotels belonging to the same sub-cluster. When the end date is lower than today's date, the validate column will be switched to NO value. The hotel profile should be the same for all hotels and set with the following values: length of stay (LOS)=1 day, number of guests=1, and horizon=365 days. The hotel profile is saved on common_marketpricing database FIG. 5. The hotel profile will be used for the daily treatment when the system starts downloading the rate availability for the hotel in question and its respective competitors.

### Hotel Competitors Screen

The rate and room type screen (FIG. 8) is displayed by drilling into the hotel competitors screen. The list of rates contains all the unrestricted best available rates imported from the web service by using syntaxes analysis and rates coming from the get_rates or get rate_by_profile services provided by other providers. This setting is made each time a new hotel enters the hotel list.

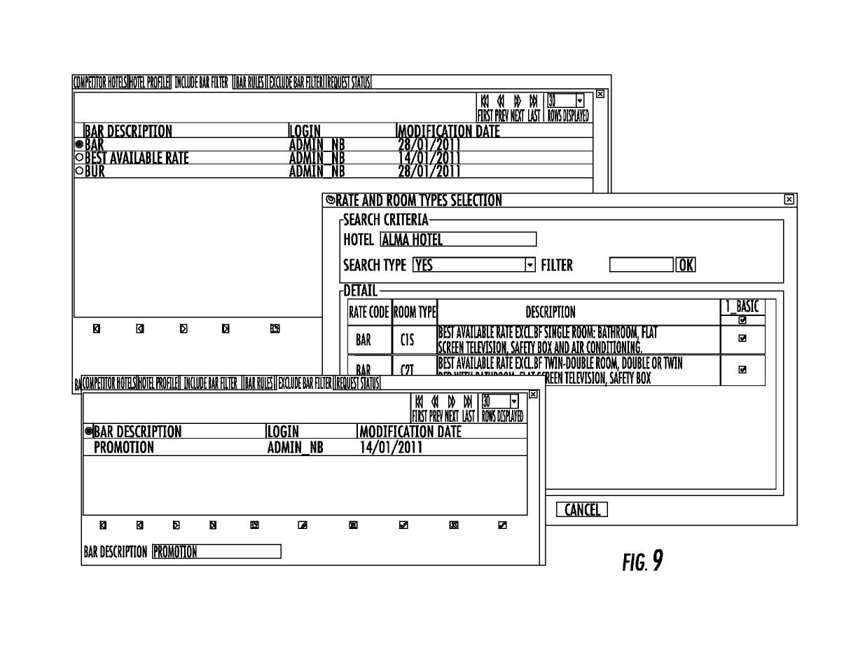

Pop up rate code/room type (see FIG. 9)
The user selects room type and rate coming from availability request and matching with limited or extended filter. By default the data is displayed for a limited filter.
The user must map each (rate, room type) of the competition to his room class (one to one selection).
The cancel button allows the user to go back to his previous selection.
All rate codes or room types are selected when the “all” check box is ticked and vice versa.
The search type combo box contains 2 items:
   Limited: for limited BAR label description available the including and excluding BAR label description tables; and
   Extended: for all available hotel rates. The BAR rate are included.
The user can extend/add new customized labels to be integrated in the words library of the label parsing process by using Administration/parameters/customized BAR label screen. The labels are defined at database level.

### Hotel New Parameter Screen

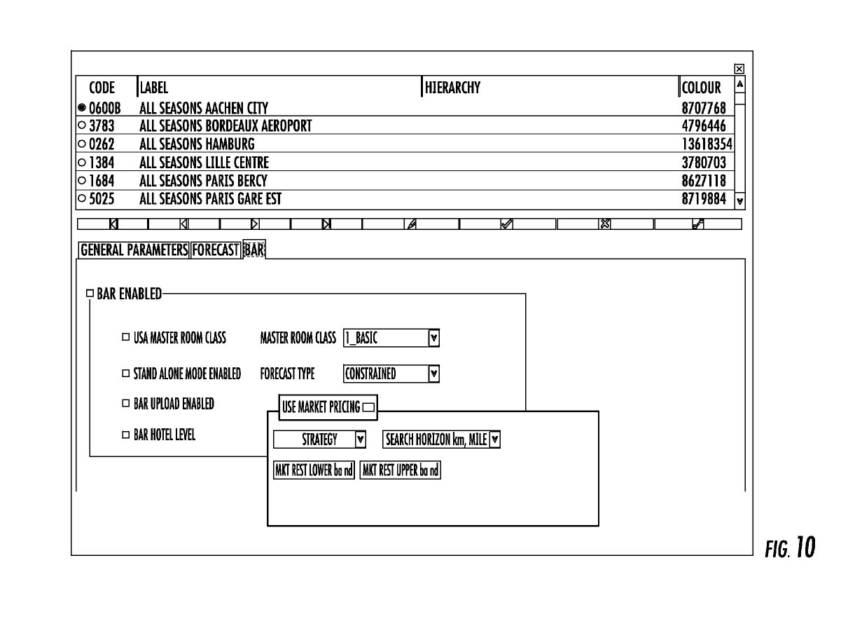

The new hotel definition screen (shown in FIG. 10) integrates the settings for the market pricing module:
Use_market_pricing: Boolean true (market pricing enabled for the hotel) or false (market pricing disabled for the hotel).
The hotel strategy: leader or follower.
Market reactivity upper band and market reactivity lower band: these 2 parameters allow the hotelier to define acceptable trend threshold.
Search radius in km or mile, this will allow us to retrieve the list of hotel neighbors located inside the radius around the user hotel.
Master room class: master room is defined for each hotel. This room class is used in market pricing rules to generate a BAR coming from these rules.

### Customized BAR Label Screen

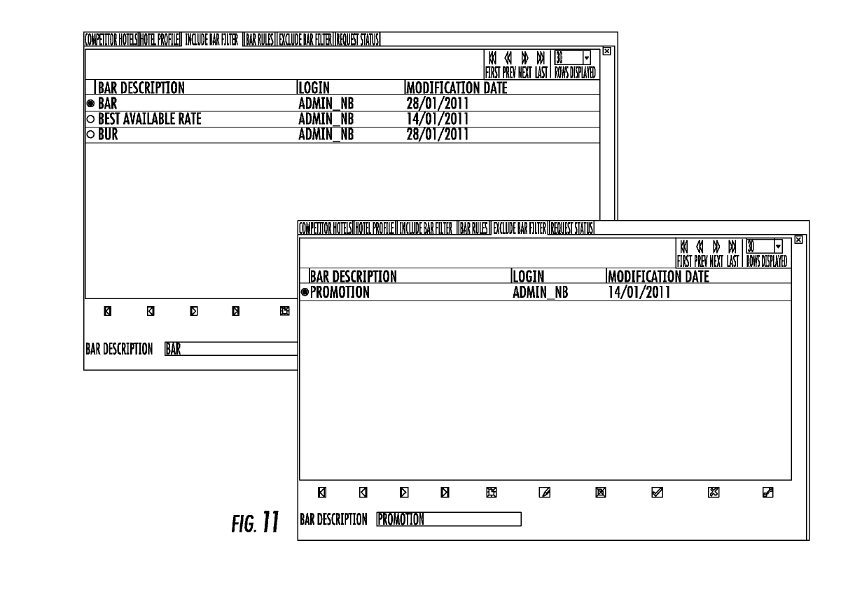

This screen (see FIG. 11) allows user to display the BAR label used in the label parsing process (label not updatable). The user can add new labels and modify and delete those created by himself. The key words are added in the including table.

The user also has the ability to exclude (rate, room type) from his (rate, room type) competition set selection exp: “promotion BAR rate”. In this case, the “promotion” key word is added to the excluding table and combined with key words belonging in the including BAR key words table described above.

### Market Price Recommendation Screen

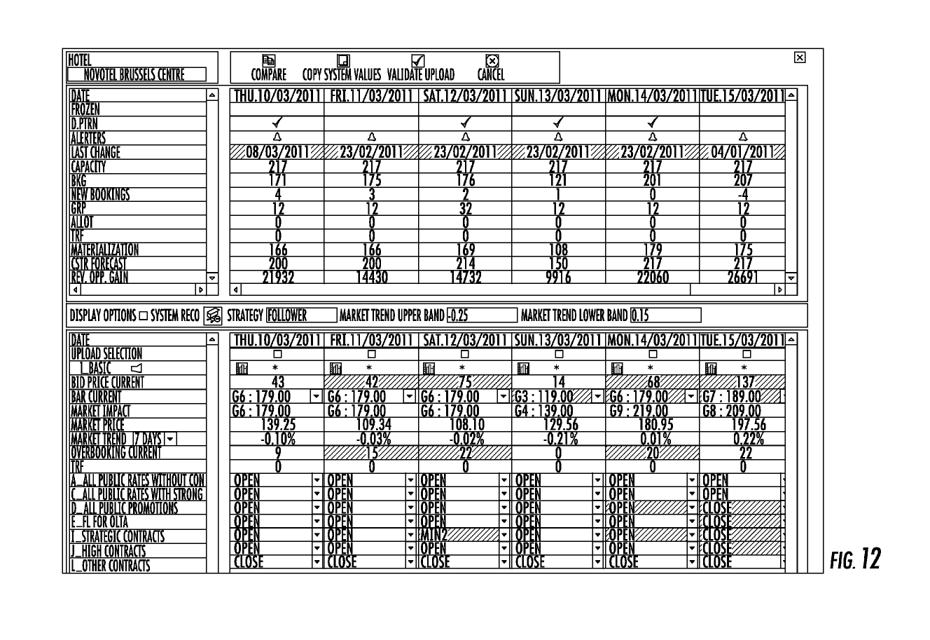

This screen (FIG. 12) allows the user to display the BAR label used in the label parsing process (label not updatable). The user can add new labels and modify and delete those created by himself. The market impact information is displayed only when the user clicks on the button (the strategy field, the market reactivity field, the next & previous buttons, market price and market trend).

### N-Day Historical Average Price

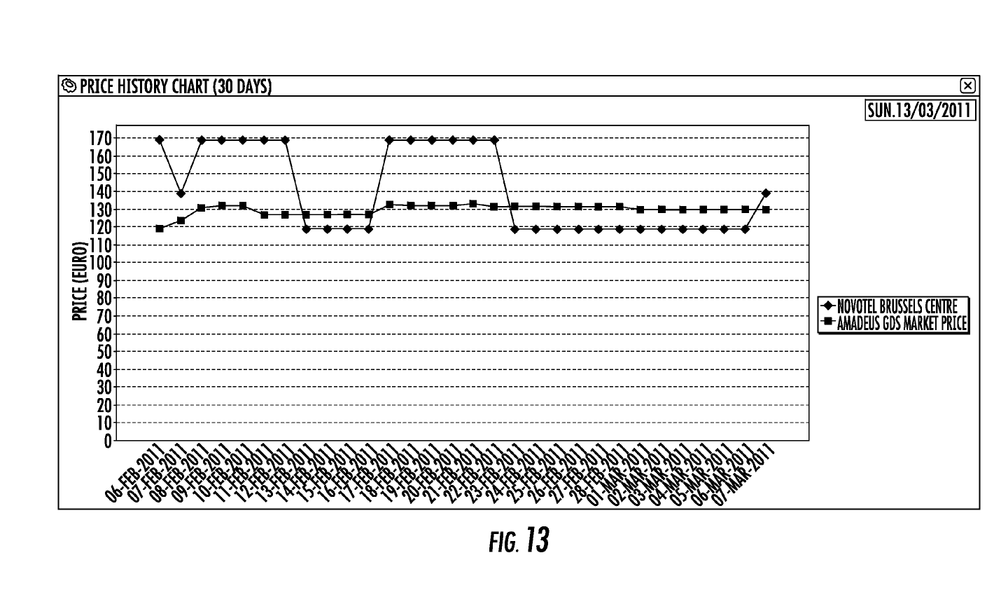

This graph (as represented in FIG. 13) allows user to display the average price over a past period of N days (N=30 in the example below), for any specific occupation day D together with the hotel BAR and the average market price calculated for the competitors set.

### Market Trend Homogeneity

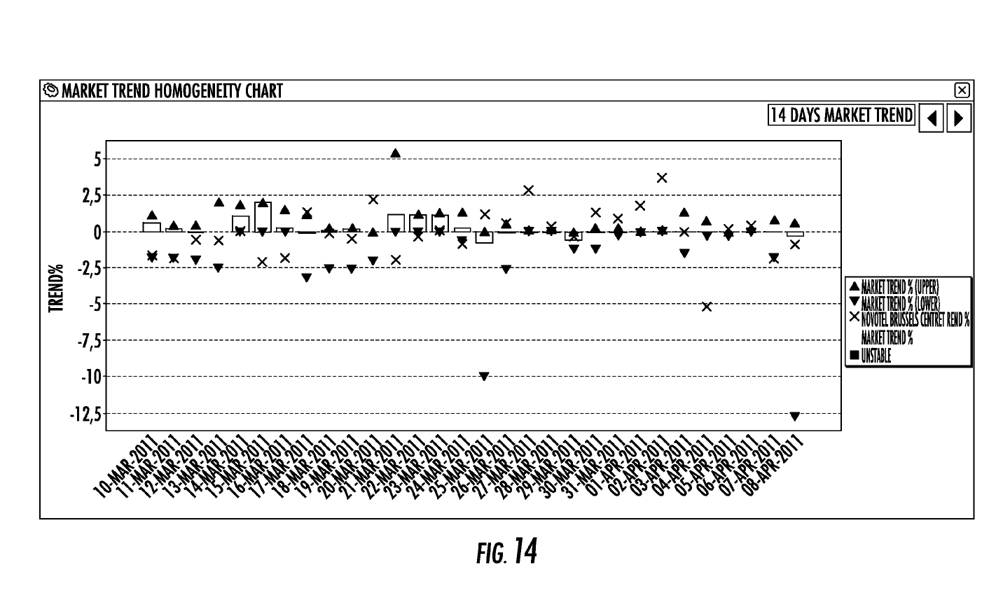

This graph (represented in FIG. 14) displays comparisons of the hotel against market trends for the next N days (here, N=30). The hotel's position is shown in comparison to the high and low trends forecast. It allows the user to understand the homogeneity of the market in terms of price consistency and market trend ranges (min/max trend).

The values are calculated taking into account the time span (7 days, 14 days, or 28 days) entered by the user in the combo box.

By default in this chart the next 30 days starting from the first day selected by the user in the LOS screen are displayed. By clicking on the next and the previous buttons, the user is able to display the trend 30 days per 30 days.

The dates where the system is considered as unstable (R2<MSC) are indicated by red bars in the histogram (however, there are none in the above example).

### Market Pricing Rules

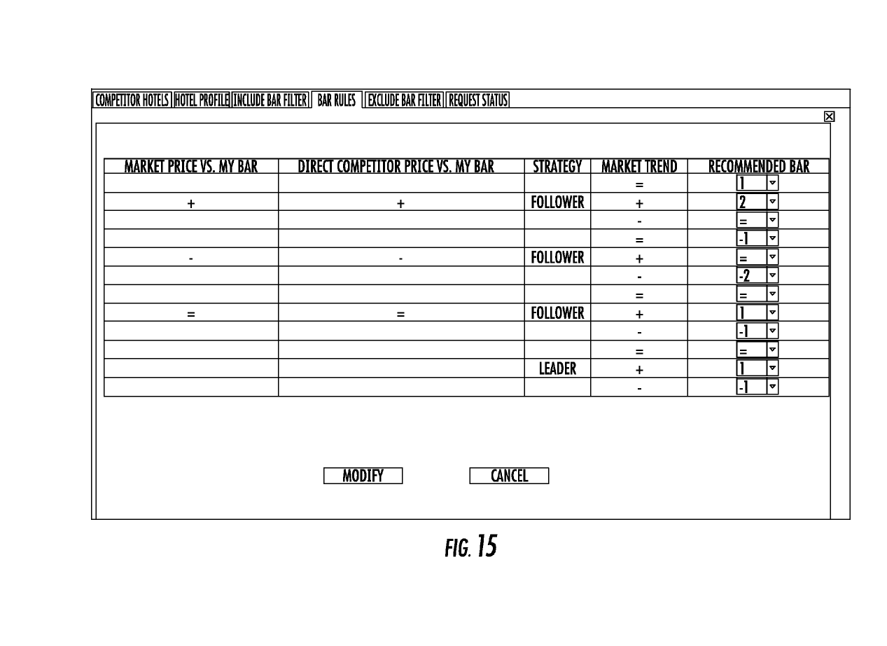

The rules are stored in the table MP_RULES_BAR and are valid for the entire cluster (see example in FIG. 15). The market pricing rules BAR screen is available under the administration/parameters/market pricing menu.

Functional controls:

The screen above enables the user to update only the recommended BAR column by clicking on the modify button.
+1: increase by 1 level the current hotel BAR,
+2: increase by 2 levels the current hotel BAR,
−1: decrease by 1 level the current hotel BAR,
−2: decrease by 2 levels the current hotel BAR,
=: The current hotel BAR is recommended (no changes)
Cancel button: cancels the previous modifications.

### Market Pricing Summary

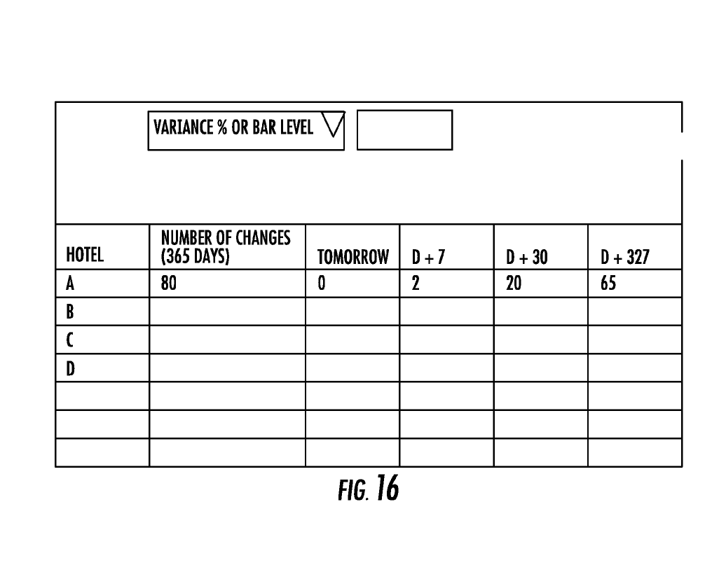

This report (as shown in FIG. 16) is displayed under the control menu. It allows the user to display directly the list of hotels where the difference exists between the BAR recommended by market pricing tool and current system BAR. That difference is displayed in terms of variance in percentage or level of the BAR. The details of the changes are displayed for several periods: tomorrow, D+7, D+30 and D+327.

The screen gives the ability to click on the line (hotel) where the changes are reported and drill into the LOS screen to validate, accept and upload the recommendations. Only the dates in difference will be displayed. When the user clicks on the column (specific date), the date selected will be displayed the middle of a 7 day period (3 days before and 3 days after the selected date).

The user can display the other dates by clicking on the next button.

The number of changes displayed in the column D+7 includes the changes for tomorrow.

Idem, the changes of D+30 includes the changes reported for D+7 and tomorrow, etc.

### Availability Request Supervision Screen

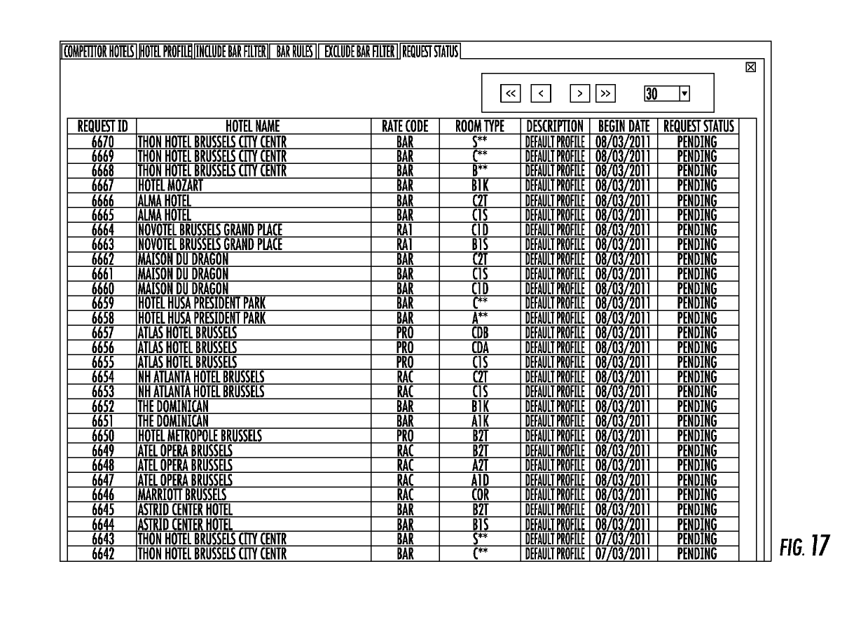

This supervision query allows the administrator and the user to oversee the execution of request availability (screen shown in FIG. 17). The lifecycle information of the requests is stored in the RS REQUEST table. There are 4 statuses available:
Status 0: Pending requests—The Orange color will be displayed.
Status 1: Ongoing requests—The Yellow color will be displayed.
Status 2: Processed requests—The Green color will be displayed.
Status 3: Failing requests—The Red color will be displayed.

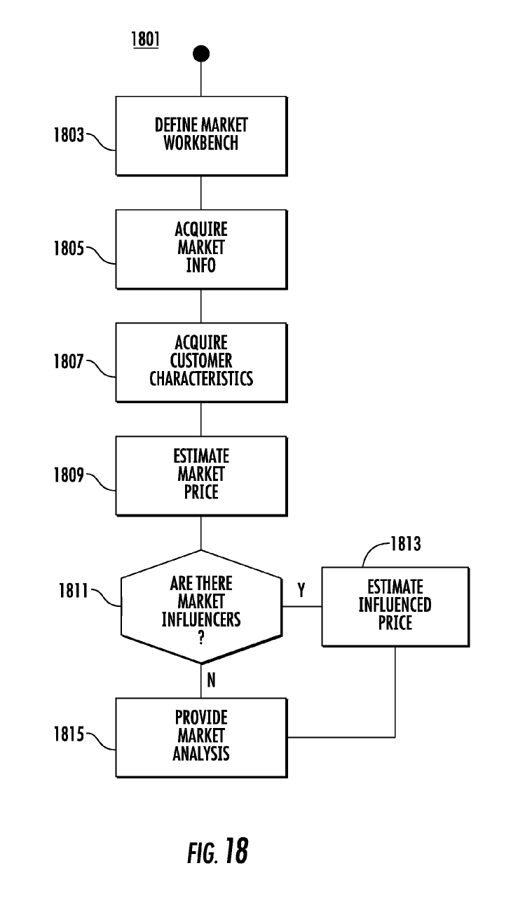

The method described above is also represented in the diagram shown in FIG. 18. The following example will use the case of hotel rooms booking Those skilled in the art will easily appreciate that the method according to the present invention could be used equally well in several different circumstances and fields where a limited number of resources is available over a period of time. Possible alternative resources include, just to make some examples: sport structures, seats on public transports, seats for shows or sporting events, slots with service providers (e.g. hospital services or specialist visits). In general the method according to the present invention can be applied to any resource management system where the resources are “perishable,” i.e. they are “wasted” if not allocated and used before predetermined time thresholds.

The method begins at black circle 1801 and then goes to 1803 where the Market Workbench is defined. Such definition can be performed with pre-defined parameters (using e.g. a semantic text search algorithm) or by prompting the user to indicate or customize his own parameters. The results of this activity could be then reviewed and possibly modified (even in a recursive manner) in order to identify an optimal definition, with the intervention of the user or by means of specific tuning software tools. For “user,” in the present example, it is meant a hotel (or someone acting for the hotel, e.g. a travel agency), but as mentioned above, other kind of user or markets could benefit from a method and system as described in the present example.

At step 1805 the system acquires information on available market databases. This step is also called rate shopping and can be done in several different ways, as explained above. In a preferred embodiment of the present invention the data are acquired from an appropriate database.

At step 1807 the system obtains the user's characteristics (e.g. from a repository) so that the estimate of market price (see box 1809) can be tailored to the specific user's characteristics. A key feature of the method and system of a preferred embodiment of the present invention is the modification of the “average market price” according to so called “market influencers.” These market influencers are sort of weights which are specific for the user and which might bring to unexpected recommended prices, depending on several factors, e.g. geographic position of the hotel, popularity of hotel brand, category of hotel.

If one or more of these market influencers are available (step 1811), the system adjusts the estimated market price (step 1813) and provides the results of the market analysis to the user. As detailed above the representation of the results can be implemented in several different ways, but generally this involves the display of tables on a computer monitor by means of an interactive user interface. The process here described can have many alterations and modifications. Also it is possible that the starting conditions are modified by the user or by change in conditions and/or in time. Just as an example, the approaching of the date for which room availability is requested can have an influence on the recommended price.

It will be appreciated that alterations and modifications may be made to the above without departing from the scope of the disclosure. Naturally, in order to satisfy local and specific requirements, a person skilled in the art may apply to the solution described above many modifications and alterations. Particularly, although the present disclosure has been described with a certain degree of particularity with reference to preferred embodiment(s) thereof, it should be understood that various omissions, substitutions and changes in the form and details as well as other embodiments are possible. Moreover, it is expressly intended that specific elements and/or method steps described in connection with any disclosed embodiment of the disclosure may be incorporated in any other embodiment as a general matter of design choice.

Similar considerations apply if the program (which may be used to implement each embodiment of the disclosure) is structured in a different way, or if additional modules or functions are provided. Likewise, the memory structures may be of other types, or may be replaced with equivalent entities (not necessarily consisting of physical storage media). Moreover, the proposed solution lends itself to be implemented with an equivalent method (having similar or additional steps, even in a different order). In any case, the program may take any form suitable to be used by or in connection with any data processing system, such as external or resident software, firmware, or microcode (either in object code or in source code). Moreover, the program may be provided on any computer-usable medium, including a non-transitory computer readable medium. The medium can be any element suitable to contain, store, communicate, propagate, or transfer the program. Examples of such medium are fixed disks (where the program can be pre-loaded), removable disks, tapes, cards, wires, fibers, wireless connections, networks, broadcast waves, and the like. For example, the medium may be of the electronic, magnetic, optical, electromagnetic, infrared, or semiconductor type.

In any case, the solution according to the present disclosure lends itself to be carried out with a hardware structure (for example, integrated in a chip of semiconductor material), or with a combination of software and hardware.

What is claimed is:

1. A system that provides an interactive user interface configured to receive and display information relating to perishable service resources, the system comprising:
an input device for receiving data from a user;
an output device for displaying data to the user;
a database server including a database that stores a neighbor list for each of a plurality of user service resources;
a processor coupled to the input device, the output device, and the database server; and
a memory coupled to the processor and including instructions that, when executed by the processor, cause the system to:
display, on the output device, a menu comprising a plurality of screens each selectable using the input device, the plurality of screens including a profile screen and a competitors screen;
receive, at the processor, a selection of the profile screen or the competitors screen;
in response to the user selecting the profile screen, display a first table including one or more of the user service resources, the first table configured to receive user input selecting a first user service resource from the one or more user service resources;
in response to the user selecting the competitors screen, display a second table including one or more neighbor service resources from the neighbor list of the first user service resource, the second table configured to, for each neighbor service resource, display an identity of the neighbor service resource and receive user input indicating whether the neighbor service resource is a competitor to the first user service resource; and
display, on the output device, a market price determined based on a price of each neighbor service resource in the neighbor list indicated as competing with the first user service resource.

2. The system of claim 1 wherein the service resources comprise hotels.

3. The system of claim 1 wherein the instructions further cause the system to:
display, for each neighbor service resource displayed in the second table, a user selectable weight to apply to the price of the neighbor service resource,
wherein the market price is an average of the weighted price of each neighbor service resource in the neighbor list indicated as competing with the first user service resource.

4. The system of claim 1 wherein the instructions further cause the system to:
display, for each user service resource in the first table, a profile including a length of stay, an occupancy level, and a validity period comprising a start date and an end date.

5. The system of claim 1 wherein the plurality of screens further includes a user service resource definition screen, and the instructions further cause the system to:
receive, at the processor, a selection of the user service resource definition screen; and
in response to the user selecting the user service resource definition screen, display a market pricing field configured to receive user input that enables or disables market pricing.

6. The system of claim 5 wherein the market pricing field further includes one or more of a search radius field configured to receive user input defining a radius used to determine which neighbor service resources to include in the neighbor list, a strategy field configured to receive user input selecting a pricing strategy, and a market reactivity field configured to receive user input defining at least one of a market reactivity upper band and a market reactivity lower band.

7. The system of claim 1 wherein the plurality of screens further includes a best available rate filter screen, and the instructions further cause the system to:
receive, at the processor, a selection of the best available rate filter screen; and
in response to the user selecting the best available rate filter screen, display a third table configured to receive user input adding or deleting a key word in one or more of an including table or an excluding table,
wherein the system excludes, from the market price determination, neighbor service resources that do not include the key word from the including table or that include the key word from the excluding table.

8. The system of claim 7 wherein the service resources comprise hotels, and the key word is searched for in data indicating a rate or room type of a hotel.

9. The system of claim 1 wherein the competitors screen includes a display button, and the instructions further cause the system to:
receive, at the processor, a selection of the display button; and
in response the user selecting the display button, display a market price recommendation screen.

10. The system of claim 1 wherein the menu includes a best available rate screen, and the instructions further cause the system to:
receive, at the processor, a selection of the best available rate screen; and
in response the user selecting the best available rate screen, display a third table configured to receive user input defining rules for adjusting a best available rate for the first user service resource in response to the market price.

11. The system of claim 10 wherein the rules include an indication of an amount to raise or lower the best available rate for the first user service resource based on one or more of the market price, the price of a specific neighbor service resource identified as a direct competitor, a marketing strategy, or a market trend.

12. A method of providing an interactive user interface on a computer, the interactive user interface configured to receive and display information relating to perishable service resources, the method comprising:
displaying a menu comprising a plurality of screens each selectable by providing input indicative of a selection, the plurality of screens including a profile screen and a competitors screen;
receiving the selection of the profile screen or the competitors screen;
in response to a user selecting the profile screen, displaying a first table including one or more of the user service resources, the first table configured to receive user input selecting a first user service resource from the one or more user service resources;
in response to the user selecting the competitors screen, displaying a second table including one or more neighbor service resources from a neighbor list of the first user service resource, the second table configured to, for each neighbor service resource, display an identity of the neighbor service resource and receive user input indicating whether the neighbor service resource is a competitor to the first user service resource; and
displaying a market price determined based on a price of each neighbor service resource in the neighbor list indicated as competing with the first user service resource.

13. The method of claim 12 further comprising:
displaying, for each neighbor service resource displayed in the second table, a user selectable weight to apply to the price of the neighbor service resource,
wherein the market price is an average of the weighted price of each neighbor service resource in the neighbor list indicated as competing with the first user service resource.

14. The method of claim 12 further comprising:
displaying, for each user service resource in the first table, a profile including a length of stay, an occupancy level, and a validity period comprising a start date and an end date.

15. The method of claim 12 wherein the plurality of screens further includes a user service resource definition screen, and further comprising:
receiving a selection of the user service resource definition screen; and
in response to the user selecting the user service resource definition screen:
displaying a market pricing field configured to receive user input that enables or disables market pricing;
displaying a search radius field configured to receive user input defining a radius used to determine which neighbor service resources to include in the neighbor list;
displaying a strategy field configured to receive user input selecting a pricing strategy; and
displaying a market reactivity field configured to receive user input defining at least one of a market reactivity upper band and a market reactivity lower band.

16. The method of claim 12 wherein the plurality of screens further includes a best available rate filter screen, and further comprising:
receiving a selection of the best available rate filter screen; and
in response to the user selecting the best available rate filter screen, displaying a third table configured to receive user input adding or deleting a key word in one or more of an including table or an excluding table,
wherein neighbor service resources that do not include the key word from the including table or that include the key word from the excluding table are excluded from the market price determination.

17. The method of claim 12 wherein the competitors screen includes a display button, and further comprising:
receiving a selection of the display button; and
in response the user selecting the display button, displaying a market price recommendation screen.

18. The method of claim 12 wherein the menu includes a best available rate screen, and further comprising:
receiving a selection of the best available rate screen; and
in response the user selecting the best available rate screen, displaying a third table configured to receive user input defining rules for adjusting a best available rate for the first user service resource in response to the market price.

19. The method of claim 18 wherein the rules include an indication of an amount to raise or lower the best available rate for the first user service resource based on one or more of the market price, the price of a specific neighbor service resource identified as a direct competitor, a marketing strategy, or a market trend.

20. A computer program product for providing an interactive user interface on a computer, the interactive user interface configured to receive and display information relating to perishable service resources, the computer program product comprising:
a non-transitory computer-readable storage medium; and
program code stored on the non-transitory computer-readable storage medium that, when executed by one or more processors, causes the one or more processors to:
display a menu comprising a plurality of screens each selectable by providing input indicative of a selection, the plurality of screens including a profile screen and a competitors screen;
receive the selection of the profile screen or the competitors screen;
in response to a user selecting the profile screen, display a first table including one or more of the user service resources, the first table configured to receive user input selecting a first user service resource from the one or more user service resources;
in response to the user selecting the competitors screen, display a second table including one or more neighbor service resources from a neighbor list of the first user service resource, the second table configured to, for each neighbor service resource, display an identity of the neighbor service resource and receive user input indicating whether the neighbor service resource is a competitor to the first user service resource; and
display a market price determined based on a price of each neighbor service resource in the neighbor list indicated as competing with the first user service resource.
